(19) United States
(12) Patent Application Publication
(10) Pub. No.: US 2021/0328910 A1
(43) Pub. Date: Oct. 21, 2021

(54) Traffic Splitting Device

(71) Applicant: Telefonaktiebolaget LM Ericsson (publ), Stockholm (SE)

(72) Inventors: Vicknesan Ayadurai, Sollentuna (SE); Massimo Condoluci, Solna (SE); Ala Nazari, Handen (SE)

(21) Appl. No.: 17/272,445

(22) PCT Filed: Sep. 12, 2018
(86) PCT No.: PCT/SE2018/050915

§ 371 Date: Mar. 1, 2021

(51) Int. Cl. H04L 12/707; H04L 12/851; H04L 12/713

(52) U.S. Cl. CPC H04L 45/22; H04L 45/586; H04L 47/24

(57) ABSTRACT

Embodiments described herein provide methods and apparatus for transmitting traffic using a first communications technology and a second communications technology to a 5 communications network. The method comprises providing a first virtual link configured to receive first traffic from a first end device, wherein the first virtual link has a plurality of first link characteristics; providing a second virtual link configured to receive second traffic from the first end device, wherein the second virtual link has a plurality of second link characteristics; transmitting the first traffic to a communications network over a first 0 network link using the first communications technology; and transmitting the second traffic to the communications network over a second network link using the second communications technology.

### TECHNICAL FIELD

Embodiments disclosed herein relate to methods and apparatus for transmitting traffic from a traffic splitting device to a communications network using a first communications technology and a second communications technology. In particular, methods and apparatus described herein provide a traffic splitting device capable of providing virtual link representations of real network links.

### BACKGROUND

It is common for a customer premises to be connected to the Internet via a fixed wired connection, for example, an asymmetric digital subscriber line (ADSL) or cable. These fixed wired technologies provide a consistent connection between the customer premises and an Internet service provider (ISP) or operator.

With rapid developments in the world of cellular communications and an emergence of newer generation technologies, such as 5G, mobile broadband connectivity is becoming a viable alternative for fixed customer premises, just as it already is for customers using wireless technologies, for example with smart mobile devices.

FIG. 1 illustrates an example of a customer premise equipment (CPE) 100 which may be placed at a customer's premise. This CPE 100 may then provide multiple network interfaces, network link 1 and network link 2, to a communications network. For example, the CPE 100 may provide one or more wired connections, such as ADSL connectivity, and one or more wireless connections, such as an antenna and a subscriber identity module or SIM. This allows the CPE to use of a combination of wired (i.e., ADSL) and wireless (e.g., LTE) connectivity.

While the CPE 100 may be located at the end-user's premises, a similar device, often described as a hybrid-access gateway (HAG), may be placed higher up in the network. Together, the CPE and HAG may operate to aggregate and combine the traffic from end-hosts flowing on multiple links or paths which may be both wired and/or wireless.

For example, the CPE 100 may provide a single link, End-Host link, to an end device over which the CPE 100 receives all traffic from the end device. The CPE 100 may then split this traffic over the network link 1 and the network link 2 for transmission to the communications network.

In some examples, the telecom operator operates both a wired network, e.g., using ADSL technology, as well as a cellular network, e.g., running the Long Term Evolution (LTE) technology. In such scenarios, with the infrastructure already in place, the operator may provide the end-user with a CPE 100 which operates with a corresponding HAG located at a convenient convergent point “higher up” within its own network.

### SUMMARY

According to some embodiments there is provided a method for transmitting traffic from a traffic splitting device to a communications network using a first communications technology and a second communications technology. The method comprises providing a first virtual link configured to receive first traffic from a first end device, wherein the first virtual link has a plurality of first link characteristics; providing a second virtual link configured to receive second traffic from the first end device, wherein the second virtual link has a plurality of second link characteristics; transmitting the first traffic to a communications network over a first network link using the first communications technology; and transmitting the second traffic to the communications network over a second network link using the second communications technology.

According to some embodiments there is provided a traffic splitting device for transmitting traffic using a first communications technology and a second communications technology to a communications network. The traffic splitting device comprises a first virtual link configured to receive first traffic from a first end device, wherein the first virtual link has a plurality of first link characteristics; a second virtual link configured to receive second traffic from the first end device, wherein the second virtual link has a plurality of second link characteristics; and a first network link configured to transmit the first traffic to the communications network using the first communications technology; and a second network link configured to transmit the second traffic to the communications network using the second communications technology.

### BRIEF DESCRIPTION OF THE DRAWINGS

For a better understanding of the present invention, and to show how it may be put into effect, reference will now be made, by way of example only, to the accompanying drawings, in which:

FIG. 1 illustrates an example of a customer premises equipment (CPE);

FIG. 2 illustrates an example of a customer premises, which in this example is a home, and its network connections;

FIG. 3 illustrates an alternative example of a customer premises, which in this example is a home, and its network connections;

FIG. 4 illustrates an example of a traffic splitting device for transmitting traffic using a first communications technology and a second communications technology to a communications network according to some embodiments;

FIG. 5 illustrates an example of a traffic splitting device for transmitting traffic using a first communications technology and a second communications technology to a communications network according to some embodiments;

FIG. 6 illustrates a method for transmitting traffic from a traffic splitting device to a communications network using a first communications technology and a second communications technology;

FIG. 7 illustrates a traffic splitting device according to some embodiments.

### DESCRIPTION

The following sets forth specific details, such as particular embodiments for purposes of explanation and not limitation. But it will be appreciated by one skilled in the art that other embodiments may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

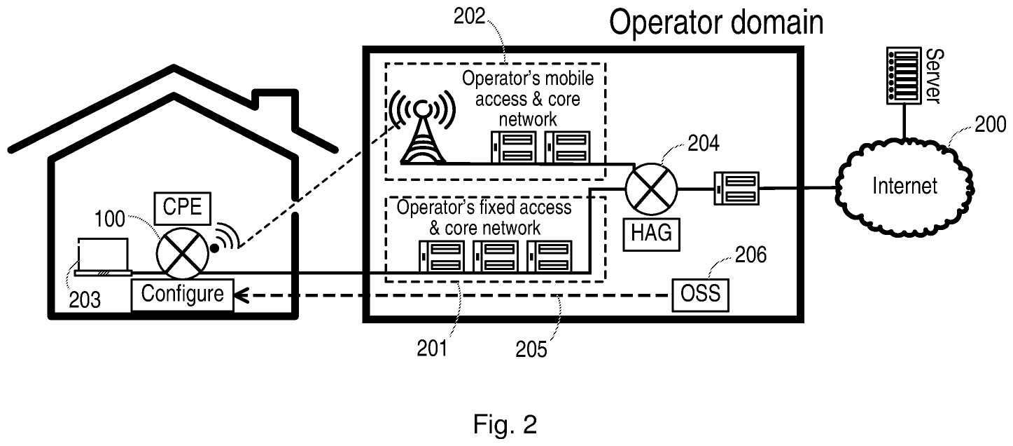

FIG. 2 illustrates a customer premises, which in this example is a home, and its network connections. The CPE 100 in this example has two physical connections to the Internet 200: a fixed wired ADSL 201 connection, and a cellular mobile broadband connection 202. It will be appreciated that, in some examples, the CPE 100 may provide two or more wireless connections, or two or more wired connections.

In this scenario both these networks, i.e., wired 201 and wireless 202, are operated by the same operator. The operator provides the end-user 203 with a CPE 100 and itself has a corresponding device, a hybrid-access gateway (HAG) 204, “high up” its own network as indicated in FIG. 2.

In this example, the HAG 204, or other device configured to aggregate the traffic received over the wired 201 and wireless 202 connections, is located beyond the operator's core network. However, it will be appreciated that this may not always be the case.

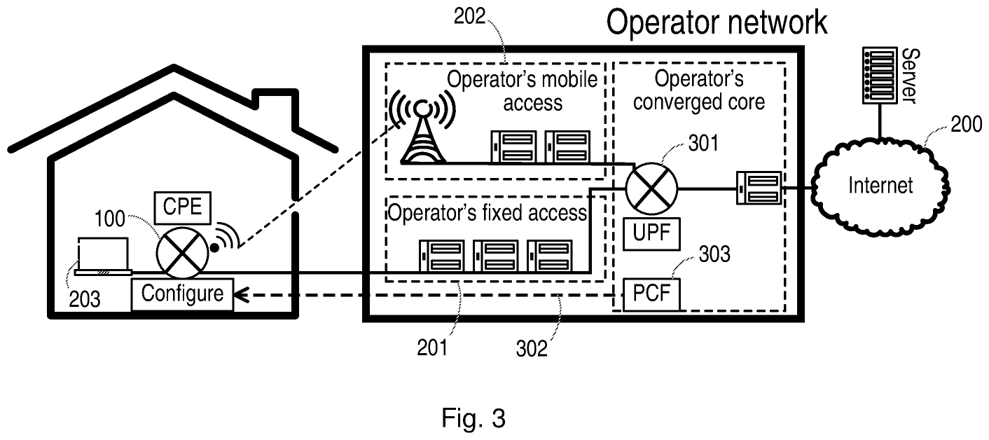

For example, FIG. 3 illustrates an alternative example of a customer premises, which in this example is a home, and its network connections. In this example, a converged 5G core network is utilised. The 5G converged core network may therefore comprise a User Plane Function (UPF) 301 capable of performing the aggregation of the traffic received over the ADSL 201 connection, and a cellular mobile broadband connection 202.

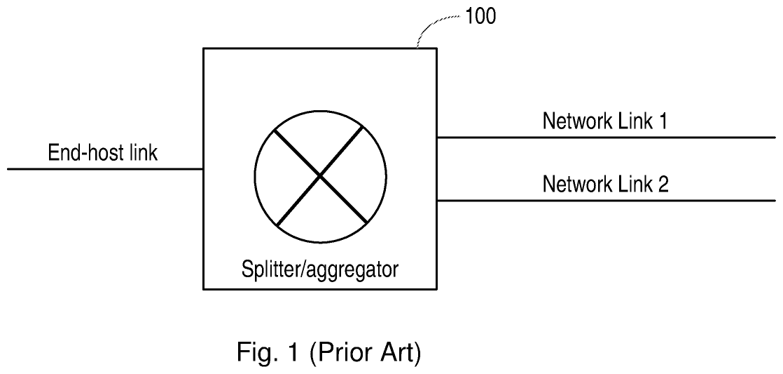

Conventionally, the CPE 100 would only provide a single connection to the end user 203, or host application, as illustrated in FIG. 1. Traffic coming in on the separate network links may then be aggregated by the CPE onto the single end user link.

The use of the combination of network links that are provided by the CPE would therefore be automatic. Whilst splitting traffic from an end user over two (or more) available network connections might appear to be the best alternative, this may not necessarily be the case for all scenarios.

For example, in some scenarios there may be economic factors to consider. For example, two network links provided by a CPE may have a different subscription cost. In this case, it may be more economical for the end device to send “expensive” (e.g., latency-critical) traffic on the more expensive link while “best-effort” (e.g., non-time-critical) traffic may be sent on the “cheaper” link. Therefore using a combination of the two links may not always be the best option for an end device.

For example, in some scenarios, different network links may have different link characteristics. For example, it is possible that for certain applications, sending traffic out on both links may prove detrimental, since a “bad” link (for example, a network link with very large latencies and/or high packet-loss rates as opposed to a “good” link having low latencies and/or low packet-loss rates) may degrade performance due to the aggregated traffic sent on the combination of “bad” plus “good” links. In this case the end device may benefit by using only the single “good” link.

It will be appreciated that different networks may support different quality of service (QoS) frameworks while different applications may have different QoS requirements. Based on this, requirement exchange may be challenging and influenced by the capabilities of the different network connections. It will be further appreciated that traffic differentiation by the network requires flow classification, which is made difficult by the wide range of different applications and the strong use of encryption today.

In some examples, there may be network performance considerations. For example, for the operator, there may be an associated cost in running each of the network links, which very likely differ for each of the network links. Some network links are therefore “more expensive” to operate, in terms of energy, other resources, or simply economics, while others are cheaper. Hence, in some scenarios it may be sufficient for the operator to provide the user with only the single “cheaper” network link, instead of using all the available connections, which would be unnecessarily more “expensive”. This could provide adequate performance for the single user, and more importantly, provide greater benefits to the overall network when viewed system-wide.

From FIG. 1 above, for example, the end device is presented with a single interface over the End-Host link, and as such, can't specify which of the network link(s), Network Link 1 and Network Link 2, to use, resulting in both of them being utilized. This may be un-necessary for the end device's requirements and potentially, result in even worse user-satisfaction performance than using a single link. Conversely, the network is also shuffling traffic on both network links to the end device, when one of them could potentially be congested, which may be detrimental and more significantly un-necessary, to maintain good system-wide performance of that network link's access-network.

Hence, despite the benefits brought about by hybrid access connectivity for fixed-wireless access, there are also subtle, but very real disadvantages to always using this connection-aggregation approach for every traffic stream, particularly from a system-wide perspective.

However, in embodiments described herein, the CPE, or traffic splitting device, may be configured to provide virtual representations of the available physical network links to the end user. By providing the end device with two (or more) virtual representations of the physical network links, intelligent applications at the end device may be able to determine which of the numerous virtual representations fulfil the requirements of the end device, and may use them accordingly. In essence, this may enable the end device, or an application running on or via an end device, to determine how to utilize the available network connectivity.

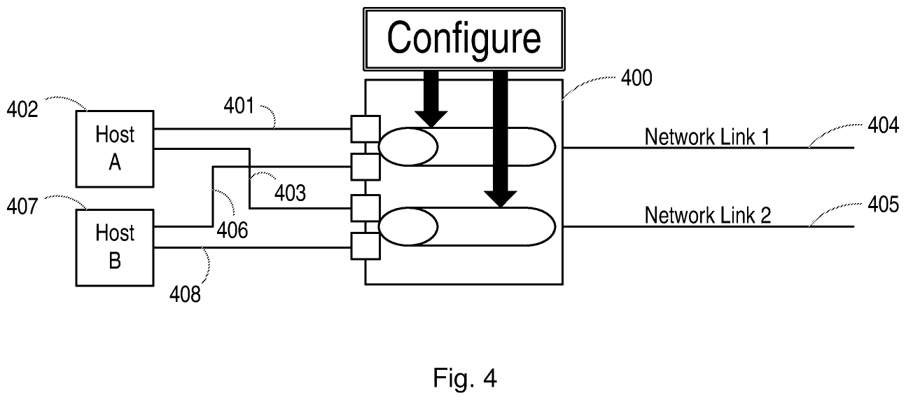

FIG. 4 illustrates an example of a traffic splitting device, for example a CPE 400, for transmitting traffic using a first communications technology and a second communications technology to a communications network. In some examples the first communications technology may be a wired technology and the second communications technology may be a wireless communications technology. However, it will be appreciated that both the first communications technology and the second communications technology may both be wired technologies, or both be wireless technologies.

The traffic splitting device 400 comprises a first virtual link 401 configured to receive first traffic from a first end device 402, wherein the first virtual link 401 has a plurality of first link characteristics. The traffic splitting device 400 further comprises a second virtual link 403 configured to receive second traffic from the first end device 402, wherein the second virtual link 403 has a plurality of second link characteristics.

The plurality of first link characteristics comprise characteristics of the first virtual link which are measureable or determinable by the first end device when coupled to the first virtual link, and the plurality of second link characteristics comprise characteristics of the second virtual link which are measureable or determinable by the first end device when coupled the second virtual link. For example, link characteristics may comprise one or more of: a latency of the first virtual link, a data transmission rate of the first virtual link, an available bandwidth of the first virtual link; and a cost of the first virtual link.

The traffic splitting device 400 may then be configured with a first network link 404 configured to transmit the first traffic to the communications network using the first communications technology and a second network link 405 configured to transmit the second traffic to the communications network using the second communications technology.

In this example, the traffic splitting device 400 is further configured with a third virtual link 406 configured to receive third traffic from a second end device 407, and a fourth virtual link 408 configured to receive fourth traffic from the second end device 407. The traffic splitting device 400 may then be configured to transmit the third traffic over the first network link 404 using the first communications technology and to transmit the fourth traffic over the second network link 405 using the second communications technology.

It will be appreciated, that there may be any number of end devices connected to transmit traffic over virtual links to the traffic splitting device, and that the traffic splitting device may be configured to send traffic received over the virtual links over the network links available.

In some examples, the virtual links 401, 403, 406 and 408 described comprise physical Ethernet connectors for coupling the end devices 402 and 407 to the traffic splitting device 400. This may enable the first end device 402 and second end device 407 to be multi-homed, for example, to have two separate IP addresses.

In some examples, an application running on the first end device 402, may require “maximum bandwidth” and as such may require the use of both virtual links 401 and 403 simultaneously, transmitting traffic over both links. In some examples, the second end device 407 may require a low-data low-latency connection and, as such, may measure or determine third link characteristics of the third virtual link 406 and fourth link characteristics of the fourth virtual link 408 in order to determine which of the third and fourth virtual links has link characteristics which are indicative of a fast link. The second end device 407 may then transmit traffic over whichever virtual link is indicated to be the fastest. By providing this cross-connection between the network links 404 and 405 with the virtual links 401, 403, 406 and 408, over-the-top applications on the first end device 402 and the second end device 407 may determine how to use the available network links 404 and 405 present to best cater to the application's needs.

In some examples, the link characteristics of each virtual link are set based on a configuration parameter. In other words, the virtual links 401, 403, 406 and 408 are described as “virtual” herein because they can be manipulated such that their link characteristics do not match the equivalent link characteristics of their associated network links.

For example, the first network link 404 may provide 100 Mbps. However, the first virtual link 401 may be configured with a link characteristic of providing 10 Mbps. In other words, the link characteristics of the virtual links may be manipulated to bias the selection of the virtual links by the end devices.

In the example illustrated in FIG. 4, the virtual links which are coupled by the traffic splitting device, to transmit traffic over the same network link (i.e. the first virtual link 401 and the third virtual link 406 are both coupled to the first network link 404, and the second virtual link 403 and the fourth virtual link 408 are both coupled to the second network link 405), are configured to have the same link characteristics.

In other words, in this example, the first link characteristics and the third link characteristics are the same, and the second link characteristics and the fourth link characteristics are the same. This configuration allows the network to bias the selection of the first network link or the second network link.

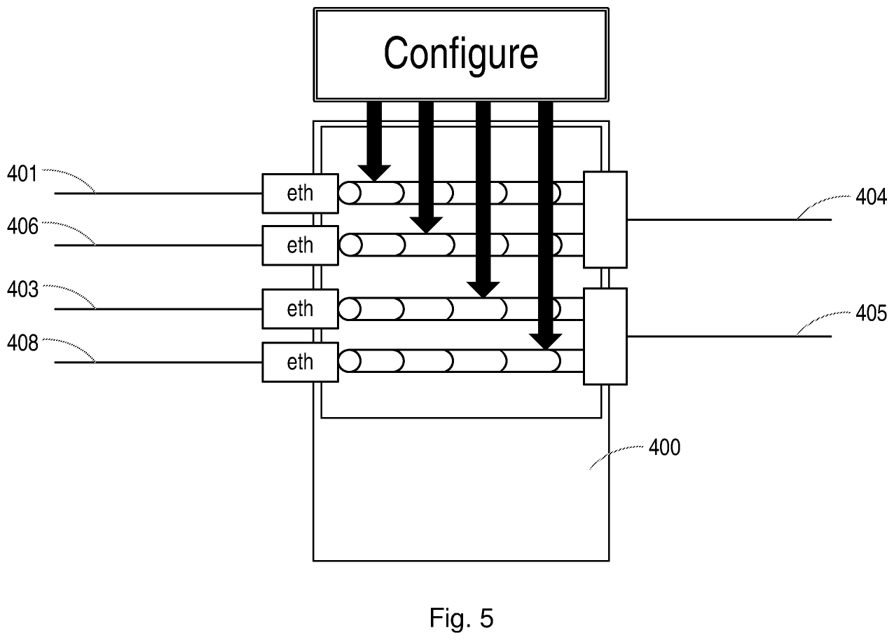

FIG. 5 illustrates an example of a traffic splitting device 400 in which link characteristics are configured for each virtual link.

In this example therefore the first link characteristics of the first virtual link 401 may be set according to at least one first configuration parameter, and the third link characteristics of the third virtual link 406 may be set according to at least one second configuration parameter. It will be appreciated that more than one configuration parameter may be utilized to determine the link characteristics for a virtual link.

These setting of the link characteristics of the different virtual links may then be configured so as to vary the behavior of the virtual interfaces on the left. While the availability of multiple links enables the end devices to decide how to connect to the network, e.g., by performing some measurements over the different virtual links to check the different link characteristics in terms of latency, data rate, etc., the configurability of these link characteristics enables the network to present different conditions to the different end devices, and bias their selection. For example it may be advantageous to deter the first end device 402 from using the first network link 404. In this example, the first link characteristics may be configured to reflect high losses, which would then induce the first end device to avoid using the first virtual link (which cross-connects to the first network link).

However, the same may not be true for the second end device 407, which may be presented with different third link characteristics on the third virtual link 406.

In particular, at least one of the plurality of third link characteristics may be different from a corresponding one of the plurality of first link characteristics. Furthermore, at least one of the plurality of fourth link characteristics may be different from a corresponding one of the plurality of second link characteristics.

Additionally, non-technical link characteristics, such as price or cost, may also be determinable by the end device, via measurable characteristics, e.g. latency. For example, an “expensive” link may be presented with a low latency link characteristics whilst a “cheap” link may be configured with a high latency. Applications on the first or second end device may then be configured to identify these characteristics and implicitly associate this to cost, thereby allowing the first or second end device to select to transmit traffic via the cheaper link, if this is so desired (i.e., the link with the largest latency).

In some embodiments, configuration parameters may be received from a manual user input at the traffic splitting device 400. For example, for privately-owned CPEs, the owner of the CPE may manually configure the link characteristics. For example, to avoid using “high-tariff” links or to enable only critical end devices at the owner's premises to use such links. In practice, this manual configuration may be carried out via a web-interface.

In some embodiments, configuration parameters may be received from a controlling network node. For example, as illustrated in FIG. 2 the controlling network node may comprise an Operations Support Systems, OSS, node 206. The OSS node 206 may transmit configuration parameters to the CPE 100 as illustrated by the arrow 205 in FIG. 2.

Alternatively, as illustrated in FIG. 3 the controlling network node may comprise a Policy Control Function, PCF, 303. The PCF 303 may transmit configuration parameters to the CPE 100 as illustrated by the arrow 302 in FIG. 2.

In these example, where the operator, which manages the multiple network links, provides the traffic splitting device 400, the configuration may be accessible remotely and updated in real time by the operator to reflect the current condition of the networks. For example, link selection by the end devices may be effectively dynamic, and may be governed according to the operator's policy framework by enforcing for example end device-oriented configurations. For example, some end devices may have a more costly subscription and therefore the link configurations for those end devices may be configured such that the service provided is better than the service provided those having a cheaper subscription.

A configuration parameter may therefore comprise a type of the first end device. For examples, an end device may comprise a single application device, for example a set-top box, which may have known requirements. For example a set top box may be known to have high bandwidth requirements. The link characteristics may therefore be set based on knowledge of the type of application that the end device is expected to be using.

The configuration parameters may also comprise a network policy associated with the first end device. For example, the first end device may have a network policy which states that it should receive traffic of a certain speed. The link characteristics may therefore be configured in order to ensure this network policy is fulfilled.

In some examples, the configuration parameters may comprise a fixed relationship between the first of the plurality of first link characteristics and a corresponding link characteristic of the first network link. In other words, a configuration parameter may for example indicate that the bandwidth of a virtual link is to be set a certain amount lower than the bandwidth of the network link that the traffic received of the virtual link will be sent over.

In some examples, the configuration parameters may set a particular value for a link characteristic.

It will be appreciated that each virtual link may have a plurality of link characteristics, for example, bandwidth, latency, etc. In some examples, one of the link characteristics of the first virtual link may be different to a corresponding one of the link characteristics of the first network link. For example the bandwidth over the first virtual link may be different to the bandwidth over the first network link. At the same time a second of the plurality of first link characteristics may be equivalent to a corresponding link characteristic of the first network link. For example, the latency of the first virtual link may be the same as the latency of the first network link.

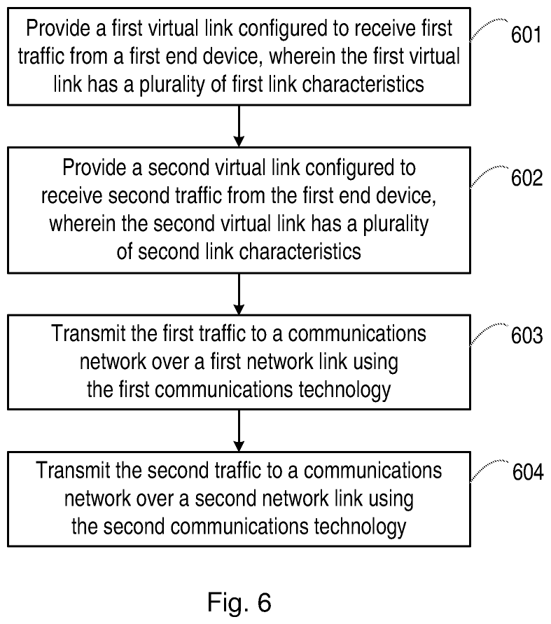

FIG. 6 illustrates a method for transmitting traffic from a traffic splitting device to a communications network using a first communications technology and a second communications technology. In some embodiments the method may be performed by the traffic splitting device 400.

In step 601, the method comprises providing a first virtual link configured to receive first traffic from a first end device, wherein the first virtual link has a plurality of first link characteristics.

In step 602, the method comprises providing a second virtual link configured to receive second traffic from the first end device, wherein the second virtual link has a plurality of second link characteristics.

In step 603, the method comprises transmitting the first traffic to a communications network over a first network link using the first communications technology.

In step 604, the method comprises transmitting the second traffic to the communications network over a second network link using the second communications technology.

It will be appreciated that the first and second link characteristics may be configured as described above. The method may also further comprises transmitting traffic to further end device(s) using further virtual and network links as described above.

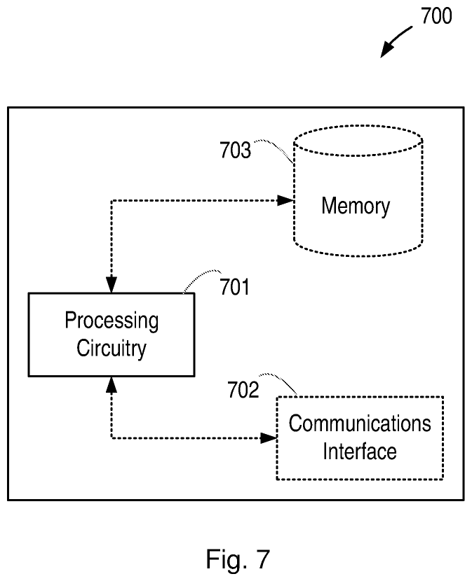

FIG. 7 illustrates a traffic splitting device 700 according to some embodiments comprising processing circuitry (or logic) 701. The processing circuitry 701 controls the operation of the traffic splitting device 700 and can implement the method described herein in relation to a traffic splitting device 700, for example the traffic splitting device 400. The processing circuitry 701 can comprise one or more processors, processing units, multi-core processors or modules that are configured or programmed to control the traffic splitting device 700 in the manner described herein. In particular implementations, the processing circuitry 701 can comprise a plurality of software and/or hardware modules that are each configured to perform, or are for performing, individual or multiple steps of the method described herein in relation to the traffic splitting device 700.

Briefly, the processing circuitry 701 of the traffic splitting device 700 is configured to: provide a first virtual link configured to receive first traffic from a first end device, wherein the first virtual link has a plurality of first link characteristics; provide a second virtual link configured to receive second traffic from the first end device, wherein the second virtual link has a plurality of second link characteristics; transmit the first traffic to a communications network over a first network link using the first communications technology; and transmit the second traffic to the communications network over a second network link using the second communications technology.

In some embodiments, the traffic splitting device 700 may optionally comprise a communications interface 702. The communications interface 702 of the traffic splitting device 700 can be for use in communicating with other nodes, such as other virtual nodes. For example, the communications interface 702 of the traffic splitting device 700 can be configured to transmit to and/or receive from other nodes requests, resources, information, data, signals, or similar. The processing circuitry 701 of the traffic splitting device 700 may be configured to control the communications interface 702 of the traffic splitting device 700 to transmit to and/or receive from other nodes requests, resources, information, data, signals, or similar.

Optionally, the traffic splitting device 700 may comprise a memory 703. In some embodiments, the memory 703 of the traffic splitting device 700 can be configured to store program code that can be executed by the processing circuitry 701 of the traffic splitting device 700 to perform the method described herein in relation to the traffic splitting device 700. Alternatively or in addition, the memory 703 of the traffic splitting device 700, can be configured to store any requests, resources, information, data, signals, or similar that are described herein. The processing circuitry 701 of the traffic splitting device 700 may be configured to control the memory 703 of the traffic splitting device 700 to store any requests, resources, information, data, signals, or similar that are described herein.

There is therefore provided a traffic splitting device and a method of splitting traffic for transmitting using two or more communications technologies.

Any appropriate steps, methods, features, functions, or benefits disclosed herein may be performed through one or more functional units or modules of one or more virtual apparatuses. Each virtual apparatus may comprise a number of these functional units.

These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

1.-38. (canceled)

39. A traffic splitting device for transmitting traffic using a first communications technology and a second communications technology to a communications network, the traffic splitting device comprising:
a first virtual link configured to receive first traffic from a first end device, wherein the first virtual link has a plurality of first link characteristics;
a second virtual link configured to receive second traffic from the first end device, wherein the second virtual link has a plurality of second link characteristics; and
a first network link configured to transmit the first traffic to the communications network using the first communications technology; and
a second network link configured to transmit the second traffic to the communications network using the second communications technology.

40. The traffic splitting device as claimed in claim 39, wherein the plurality of first link characteristics comprise characteristics of the first virtual link which are measureable or determinable by the first end device when coupled to the first virtual link, and the plurality of second link characteristics comprise characteristics of the second virtual link which are measureable or determinable by the first end device when coupled the second virtual link.

41. The traffic splitting device as claimed in claim 39, wherein a first of the plurality of first link characteristics is based on a first configuration parameter.

42. The traffic splitting device as claimed in claim 41, wherein the first configuration parameter comprises a type of the first end device.

43. The traffic splitting device as claimed in claim 41, wherein the first configuration parameter comprises one or more of: a network policy associated with the first end device, a fixed relationship between the first of the plurality of first link characteristics and a corresponding link characteristic of the first network link, and a set value for the first link characteristic.

44. The traffic splitting device as claimed in claim 39, wherein a first of the plurality of second link characteristics is based on a second configuration parameter.

45. The traffic splitting device as claimed in claim 39, wherein:
a first of the plurality of first link characteristics is based on the first configuration parameter, wherein the traffic splitting device is configured to receive the first configuration parameter from a manual user input; and/or
a first of the plurality of second link characteristics is based on a second configuration parameter, wherein the traffic splitting device is configured to receive the second configuration parameter from a manual user input.

46. The traffic splitting device as claimed in claim 41, wherein:
a first of the plurality of first link characteristics is based on the first configuration parameter, wherein the traffic splitting device is configured to receive the first configuration parameter from a controlling network node; and/or
a first of the plurality of second link characteristics is based on a second configuration parameter, wherein the traffic splitting device is configured to receive the second configuration parameter from a controlling network node.

47. The traffic splitting device as claimed in claim 46, wherein the controlling network node comprises an Operations Support Systems (OSS) node.

48. The traffic splitting device as claimed in claim 46, wherein the controlling network node comprises a Policy Control Function (PCF).

49. The traffic splitting device as claimed in claim 39, wherein a second of the plurality of first link characteristics is equivalent to a corresponding link characteristic of the first network link.

50. The traffic splitting device as claimed in claim 39, wherein a second of the plurality of second link characteristics is equivalent to a corresponding link characteristic of the second network link.

51. The traffic splitting device as claimed in claim 39, further comprising:
a third virtual link configured to receive traffic from a second end device, wherein the third virtual link has a plurality of third link characteristics; and
wherein the first network link is configured to transmit traffic received on the third virtual link from the second end device to the communications network using the first communications technology.

52. The traffic splitting device as claimed in claim 51, further comprising:
a fourth virtual link configured to receive traffic from the second end device, wherein the fourth virtual link has a plurality of fourth link characteristics; and
wherein the second network link is configured to transmit traffic received on the fourth virtual link from the second end device to the communications network using the second communications technology.

53. The traffic splitting device as claimed in claim 52, wherein at least one of the plurality of fourth link characteristics is different from a corresponding one of the plurality of second link characteristics.

54. The traffic splitting device as claimed in claim 51, wherein at least one of the plurality of third link characteristics is different from a corresponding one of the plurality of first link characteristics.

55. The traffic splitting device as claimed in claim 39, wherein the first communications technology comprises a wireless communications technology and the second communications technology comprises a wired communications technology.

56. The traffic splitting device as claimed in claim 39, wherein the plurality of first link characteristics comprises one or more of: a latency of the first virtual link, a data transmission rate of the first virtual link, an available bandwidth of the first virtual link; and a cost of the first virtual link.

57. A method for transmitting traffic from a traffic splitting device to a communications network using a first communications technology and a second communications technology, the method comprising:
providing a first virtual link configured to receive first traffic from a first end device, wherein the first virtual link has a plurality of first link characteristics;
providing a second virtual link configured to receive second traffic from the first end device, wherein the second virtual link has a plurality of second link characteristics;
transmitting the first traffic to a communications network over a first network link using the first communications technology; and
transmitting the second traffic to the communications network over a second network link using the second communications technology.

58. A traffic splitting device for transmitting traffic using a first communications technology and a second communications technology to a communications network, the traffic splitting device comprising:
processing circuitry configured to:
provide a first virtual link configured to receive first traffic from a first end device, wherein the first virtual link has a plurality of first link characteristics;
provide a second virtual link configured to receive second traffic from the first end device, wherein the second virtual link has a plurality of second link characteristics;
transmit the first traffic to a communications network over a first network link using the first communications technology; and
transmit the second traffic to the communications network over a second network link using the second communications technology.
